(19) United States
(12) Patent Application Publication
(10) Pub. No.: US 2026/0028183 A1
(43) Pub. Date: Jan. 29, 2026

(54) STORAGE AND RETRIEVAL SYSTEM AND METHOD

(71) Applicant: Ocado Innovation Limited, Hatfield (GB)

(72) Inventor: Lars Sverker Ture LINDBO, Stockholm (SE)

(21) Appl. No.: 19/349,229

(22) Filed: Oct. 3, 2025

Related U.S. Application Data
(63) Continuation of application No. PCT/EP2024/059145, filed on Apr. 4, 2024.

(30) Foreign Application Priority Data
Apr. 5, 2023 (GB) 2305075.0

(51) Int. Cl. B65G 1/04

(52) U.S. Cl. CPC B65G 1/0485; B65G 1/0464; B65G 1/0471

(57) ABSTRACT

A storage and retrieval system comprising: a grid; a plurality of containers located in stacks beneath the grid; a furcated container conveyor comprising a stem and two or more branches connected to the stem by a junction, each branch comprising a grid interface section that is at least partially disposed beneath the grid, and the stem comprising at least one section that is disposed beyond the grid; and a plurality of robotic load handling devices arranged to move along the grid and configured to move the containers between the stacks and the grid interface sections of the furcated container conveyor.

### TECHNICAL FIELD

The disclosure herein relates to automated storage and retrieval systems. More specifically but not exclusively, it relates to a storage and retrieval system using stackable containers stored in a workspace located beneath a grid, where the containers, holding objects, are transported using load handling devices travelling on top of the grid. Furthermore, it relates to a range of variations to the system that enables the efficient exchange of containers between the stacks and any peripherals or external systems.

### BACKGROUND

Some commercial and industrial activities require systems that enable the storage and retrieval of a large number of different products. One known type of system for the storage and retrieval of items in multiple product lines involves arranging storage bins or containers in stacks on top of one another, the stacks being arranged in rows. The storage bins or containers are accessed from above, removing the need for aisles between the rows and allowing more containers to be stored in a given space.

GB2520104A, the contents of which are incorporated herein by reference, describes a system in which stacks of containers are arranged within a frame structure. The containers are accessed by robotic load handling devices operative on tracks located on the top of the frame structure. A system of this type is illustrated schematically in FIGS. 1 to 4 of the accompanying drawings.

The process of adding an item to storage containers is referred to as a decant operation, as inbound items are removed from any shipping containers and/or packaging and decanted into some separate storage means. Storage and retrieval system therefore typically include one or more decant stations at which decant operations are performed, wherein the decant station is arranged to receive storage containers and to enable items to be added to the contents of the storage containers. Then, to fulfil a customer order, one or more storage containers containing outbound items are delivered to a picking station, at which the ordered products are picked out of the containers, e.g. by a manual picker or by a robotic picking device.

In storage and retrieval systems such as those described above, storage containers are typically moved between the stacks and any peripheral devices/inventory handling stations, such as decant stations, picking stations or combined pick and decant station of the systems, by the robotic load handling devices. However, some systems also include conveyor interfaces that transport containers between the frame structure and the peripherals. For example, GB2546601A describes such a storage and retrieval system in which the robotic load handling devices can deposit containers on to conveyor belts that then transfer the containers from the frame structure to a vehicle loading area.

The present invention aims to overcome the problems associated with storage and retrieval systems that include conveyor interfaces between the frame structure and any other part of the system, such as any peripherals, or any external system. In particular, these conveyor interfaces typically have limited throughput, which limits the overall efficiency of the system.

It is against this background that the present invention has been devised.

### BRIEF SUMMARY

The arrangements described herein provide a scalable and cost effective means for increasing the throughput, and therefore the overall efficiency, of storage and retrieval systems that include conveyor interfaces.

According to a first aspect, there is provided a storage and retrieval system. The storage and retrieval system comprises a grid, a plurality of containers located in stacks beneath the grid, and a furcated container conveyor. The furcated container conveyor comprises a stem and two or more branches connected to the stem by a junction, each branch comprising a grid interface section that is at least partially disposed beneath the grid, and the stem comprising at least one section that is disposed beyond the grid. The storage and retrieval system further comprises a plurality of robotic load handling devices arranged to move along the grid and configured to move the containers between the stacks and the grid interface sections of the furcated container conveyor.

The stacks may be located beneath a storage interface portion of the grid and each grid interface section is then at least partially disposed beneath a conveyor interface portion of the grid. The storage interface portion may be continuous with the or each conveyor interface portion of the grid. The grid interface sections of each branch may be arranged to be parallel.

The junction may connect the stem to the two or more branches and may be arranged to direct containers between the stem and the two or more branches. The junction may be arranged to selectively direct containers between the stem and the two or more branches, preferably under the control of a central controller.

The grid may define grid spaces and each stack of containers may then be disposed beneath a grid space. The load handling devices may be configured to raise and lower containers to and from each stack through the corresponding grid spaces. Each grid interface section may be arranged beneath a plurality of the grid spaces and thereby provide a plurality of transfer positions at which containers are transferred between the grid interface section and the load handling devices, and such that a container supported on the grid interface section at one of the transfer positions is aligned with a grid space. The grid interface sections of each branch may be separated by at least one grid space and by no more than four grid spaces.

Each branch of the furcated container conveyor may comprise an accumulation section connected to the grid interface section, the accumulation section being disposed between the grid interface section and the stem. The accumulation section may connect the grid interface section to the junction.

The furcated container conveyor may be a furcated outbound container conveyor that is arranged to convey containers away from the grid, and the junction may then comprise a convergent section that is arranged to merge containers conveyed from the two or more branches on to the stem. The convergent section may be arranged to direct each container conveyed from each branch on to the stem, and preferably to selectively direct each container under the control of a central controller. The stem may comprise at least one downstream section of the furcated container conveyor.

The furcated container conveyor may be a furcated inbound container conveyor that is arranged to convey containers to the grid, and the junction may then comprise a divergent section that is arranged to divert containers conveyed from the two or more branches on to the stem. The divergent section may be arranged to direct each container conveyed from the stem on to one of the branches, and preferably to selectively direct each container under the control of a central controller. The stem may comprise at least one upstream section of the furcated inbound container conveyor.

The storage and retrieval system may further comprise a furcated outbound container conveyor that is arranged to convey containers away from the grid. The furcated outbound container conveyor may then comprise a stem and two or more branches connected to the stem by a junction, each branch comprising a grid interface section that is at least partially disposed beneath the grid, and the stem comprising at least one section that is disposed beyond the grid, and the junction comprising a convergent section that is arranged to merge containers conveyed from the two or more branches on to the stem.

The grid interface sections of the furcated outbound container conveyor and the furcated inbound container conveyor may then be alternately distributed. The furcated outbound container conveyor and the furcated inbound container conveyor may be arranged such that each grid interface section of the furcated outbound container conveyor is parallel with and adjacent to a grid interface section of the furcated inbound container conveyor. The grid interface sections of the furcated outbound container conveyor and the furcated inbound container conveyor may be separated by no more than four grid spaces.

The grid interface sections of the furcated outbound container conveyor and the furcated inbound container conveyor may be interdigitated. The grid interface sections of the furcated outbound container conveyor and the furcated inbound container conveyor may be parallel to one another, extend in opposite directions and be alternately distributed.

According to a second aspect, there is provided a storage and retrieval system. The storage and retrieval system comprises a grid, a plurality of containers located in stacks beneath the grid, and a container conveyor. The container conveyor may comprise a plurality of conveyor sections that are independently operable, the plurality of conveyor sections comprising a grid interface section, an accumulation section and at least one further section, wherein grid interface section is at least partially disposed beneath the grid, the at least one further section is disposed beyond the grid, and the accumulation section connects the grid interface section to the at least one further section. The storage and retrieval system further comprises a plurality of robotic load handling devices arranged to move along the grid and configured to move the containers between the stacks and the grid interface sections of the container conveyor.

The stacks may be located beneath a storage interface portion of the grid and the grid interface section is then at least partially disposed beneath a conveyor interface portion of the grid. The storage interface portion may be continuous with the or each conveyor interface portion of the grid.

The grid may define grid spaces and each stack of containers may be disposed beneath a grid space. The load handling devices may be configured to raise and lower containers to and from each stack through the corresponding grid spaces. Each grid interface section may be arranged beneath a plurality of the grid spaces and thereby provide a plurality of transfer positions at which containers are transferred between the grid interface section and the load handling devices, and such that a container supported on the grid interface section at one of the transfer positions is aligned with a grid space.

The accumulation section may be arranged to convey containers between the grid interface section and the at least one further section. The accumulation section may extend at least partially out from beneath the grid.

The plurality of conveyor sections may comprise a section that is configured to transport containers in a direction that is at least partially vertical. The plurality of conveyor sections may comprise an intermediate section that is disposed between the grid interface section and the at least one further section, and the intermediate section may be configured to transport containers in a direction that is at least partially vertical. The accumulation section may be configured to transport containers in a direction that is at least partially vertical.

The container conveyor may be an outbound container conveyor that is arranged to convey containers away from the grid. The container conveyor may be an inbound container conveyor that is arranged to convey containers away to the grid. The storage and retrieval system may then further comprise an outbound container conveyor that is arranged to convey containers away from the grid.

The outbound container conveyor may comprise a plurality of conveyor sections that are independently operable, the plurality of conveyor sections comprising a grid interface section, an accumulation section and at least one further section, wherein grid interface section is at least partially disposed beneath the grid, the at least one further section is disposed beyond the grid, and the accumulation section connects the grid interface section to the at least one further section. The inbound container conveyor and the outbound container conveyor may be arranged such that the grid interface section of the inbound container conveyor is parallel with and adjacent to the grid interface section of the outbound container conveyor.

The grid may define grid space, each stack of containers may then be disposed beneath a corresponding grid space, and the grid interface sections of the inbound container conveyor and the outbound container conveyor may be separated by at least one grid space and by no more than four grid spaces.

According to a third aspect, there is provided a storage and retrieval system. The storage and retrieval system comprises a first level grid, a second level grid, the first level grid being lower than the second level grid, a plurality of containers located in stacks beneath the first level grid and in stacks beneath the second level grid, and a container conveyor. The container conveyor comprises a first grid interface section that is at least partially disposed beneath the first level grid, a second grid interface section that is at least partially disposed beneath the second level grid, and one or more intermediate sections that connect the first grid interface section to the second grid interface section. The storage and retrieval system further comprises a first plurality of robotic load handling devices arranged to move along the first level grid and configured to move containers between the stacks beneath the first level grid and the first grid interface section of the container conveyor, and a second plurality of robotic load handling devices arranged to move along the second level grid and configured to move containers between the stacks beneath the second level grid and the second grid interface section of the container conveyor.

The plurality of containers may be distributed between a first set of stacks that are disposed beneath the first grid and a second set of stacks are disposed beneath the second grid.

Each of the one or more intermediate sections may be arranged to convey containers between the first grid interface portion and the second grid interface portion. The one or more intermediate sections may be disposed beyond both the first level grid and the second level grid. At least one of the one or more intermediate sections may be configured to transport containers in a direction that is at least partially vertical.

The storage and retrieval system may further comprise one or more further container conveyors, each of the one or more further container conveyors comprising a first grid interface section that is at least partially disposed beneath the first grid, a second grid interface section that is at least partially disposed beneath the second grid, and one or more intermediate sections that connect the first grid interface portion to the second grid interface portion;

The container conveyor may be an upward container conveyor that is arranged to convey containers away from the first grid towards the second grid. At least one of the one or more intermediate sections may then be arranged to transport containers upward towards the second grid.

The container conveyor may be a downward container conveyor that is arranged to convey containers away from the second grid towards the first grid. At least one of the one or more intermediate sections may then be arranged to transport containers downward towards the first grid. The storage and retrieval system may then further comprise an upward container conveyor that is arranged to convey containers away from the first grid towards the second grid. The upward container conveyor may comprise a first grid interface section that is at least partially disposed beneath the first grid, a second grid interface section that is at least partially disposed beneath the second grid, and one or more intermediate sections that connect the first grid interface portion to the second grid interface portion. At least one of the one or more intermediate sections of the upward container conveyor may be arranged to transport containers upward towards the second grid.

In each of the above aspects, each conveyor section may comprise one or more of a belt conveyor device, a roller conveyor device, a chain conveyor device, a slat conveyor device, and an accumulator conveyor device.

In each of the above aspects, the storage and retrieval system may further comprise rails or tracks arranged to form the grid and on which the load handling devices are arranged to move. The storage and retrieval system may comprise two substantially perpendicular sets of tracks or rails arranged to form the grid. The storage and retrieval system may comprise a first set of substantially parallel rails or tracks and a second set of substantially parallel rails or tracks extending substantially perpendicularly to the first set in a substantially horizontal plane. The storage and retrieval system may comprise a set of uprights, the uprights supporting the tracks, the uprights and tracks together defining a framework.

In each of the above aspects, the load handling devices may comprise a body mounted on wheels, a first set of wheels being arranged to engage with at least two tracks of the first set of tracks, the second set of wheels being arranged to engage with at least two tracks of the second set of tracks, the first set of wheels being independently moveable and driveable with respect to the second set of wheels such that when in motion only one set of wheels is engaged with the grid at any one time thereby enabling movement of the load handling device along the tracks to any point on the grid by driving only the set of wheels engaged with the tracks, the load handling devices further comprising means for removing or replacing containers from the stacks.

Other variations and advantages will become apparent from the following description.

### BRIEF DESCRIPTION OF THE DRAWINGS

These and other aspects of the present disclosure will now be described, by way of example only, and with reference to the accompanying drawings, in which:

FIG. 1 is a schematic perspective view of a frame structure for housing a plurality of stacks of bins in a known storage system;

FIG. 2 is a schematic plan view of part of the frame structure of FIG. 1;

FIGS. 3a, 3b, and 3c are schematic perspective views of a load handling device of a known storage system arranged to travel on a grid of the storage system, illustrating different aspects of its structure and operation.

FIG. 4 is a schematic perspective view of the known storage system of FIGS. 1 and 2, showing multiple load handling devices operating on the grid above the stacks of storage containers.

FIG. 5a is a schematic perspective view of a portion of a storage system that comprises grid interfacing container conveyors;

FIG. 5b is a schematic top-down view of the portion of the storage system of FIG. 5a;

FIG. 6a is a schematic perspective view of a portion of a storage system that comprises a furcated inbound container conveyor;

FIG. 6b is a schematic top-down view of the portion of the storage system of FIG. 6b;

FIG. 6c is a schematic top-down view of a portion of a storage system that comprises a furcated outbound container conveyor;

FIG. 7 is a schematic perspective view of a portion of a storage system that comprises a furcated container conveyor;

FIG. 8a is a schematic perspective view of a portion of a storage system that comprises a furcated inbound container conveyor and a furcated outbound container conveyor

FIG. 8b is a schematic top-down view of the portion of the storage system of FIG. 8b;

FIG. 9a is a schematic perspective view of a portion of a storage system that comprises a sloped, grid interfacing container conveyor;

FIG. 9b is a schematic perspective view of a portion of a storage system that comprises a vertical, grid interfacing container conveyor;

FIG. 9c is a schematic perspective view of a portion of an alternative storage system that comprises a vertical, grid interfacing container conveyor; and

FIG. 10 is a schematic perspective view of a portion of a storage system that comprises a multi-level grid and a plurality of grid interfacing, container conveyors.

In the figures, like features are denoted by like reference signs where appropriate.

### DETAILED DESCRIPTION

The following embodiments represent preferred examples of how the systems and methods of the present disclosure may be practiced, but they are not necessarily the only examples of how this could be achieved. These examples are described in sufficient detail to enable those skilled in the art to practice the systems and methods of the present disclosure. Other examples may be utilised and structural changes may be made without departing from the scope of the present disclosure as defined in the appended claims. Moreover, direction references and any other terms having an implied orientation are given by way of example to aid the reader's understanding of the particular examples described herein. They should not be read to be requirements or limitations, particularly as to the position, orientation, or use of systems unless specifically set forth in the appended claims. Similarly, connection references (e.g., attached, coupled, connected, joined, secured, and the like) are to be construed broadly and may include intermediate members between a connection of elements and relative movement between elements. As such, connection references do not necessarily infer that two elements are directly connected and in fixed relation to each other, unless specifically set forth in the appended claims. Similarly, wording such as “movement in the n-direction” and any comparable wording, where n is one of x, y or z, is intended to mean movement substantially along or parallel to the n-axis, in either direction (i.e., towards the positive end of the n-axis or towards the negative end of the n-axis).

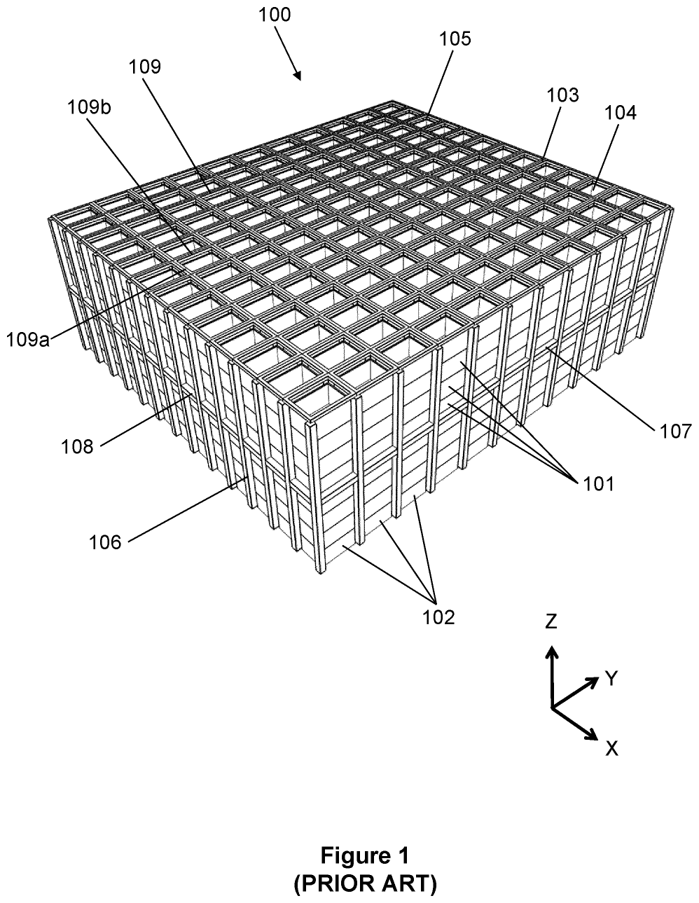

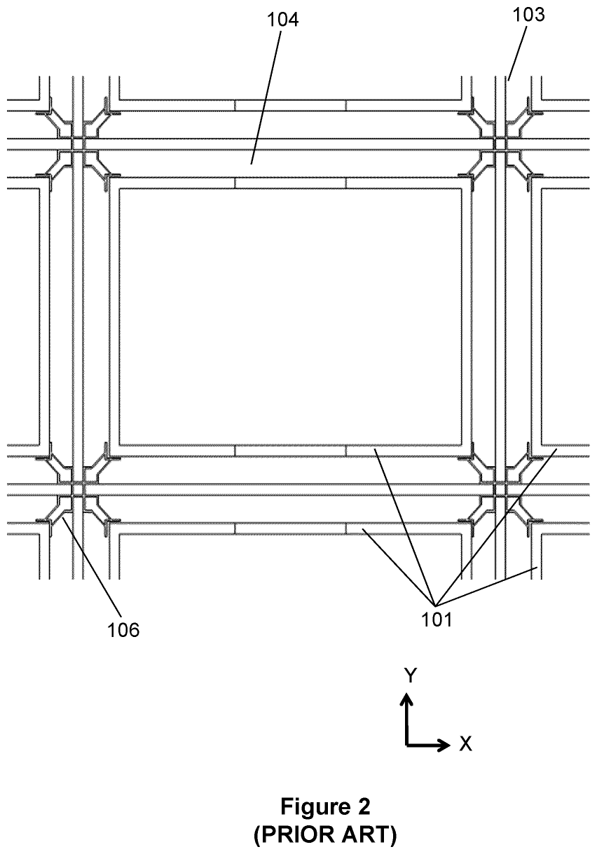

FIG. 1 is a schematic perspective view of a known storage and retrieval system 100 comprising a plurality of stacks 102 of storage containers 101 stored in a workspace located beneath a grid 103, and FIG. 2 is a top-down view showing a single stack 102 of storage containers 101 arranged beneath the grid 103. As shown in FIG. 1, the stackable storage containers 101, known as bins, are stacked on top of one another to form the stacks 102. The grid 103 defines grid spaces 104 and each stack 102 of containers 101 is disposed beneath and aligned with a grid space 104 such that the containers 101 in a stack 102 can be accessed through a grid space 104. Each storage container 101 typically holds a plurality of product items (not shown), and the product items within a storage container 101 may be identical, or may be of different product types depending on the application.

The grid 103 is part of a frame structure 105 that comprises a plurality of upright members 106 that support horizontal members 107, 108. A first set of parallel horizontal members 107 is arranged perpendicularly to a second set of parallel horizontal members 108 to form a plurality of horizontal grid structures supported by the upright members 106. The members 106, 107, 108 are typically manufactured from metal. The containers 101 are stacked between the members 106, 107, 108 of the frame structure 105, so that the frame structure 105 guards against horizontal movement of the stacks 102 of containers 101, and guides vertical movement of the containers 101.

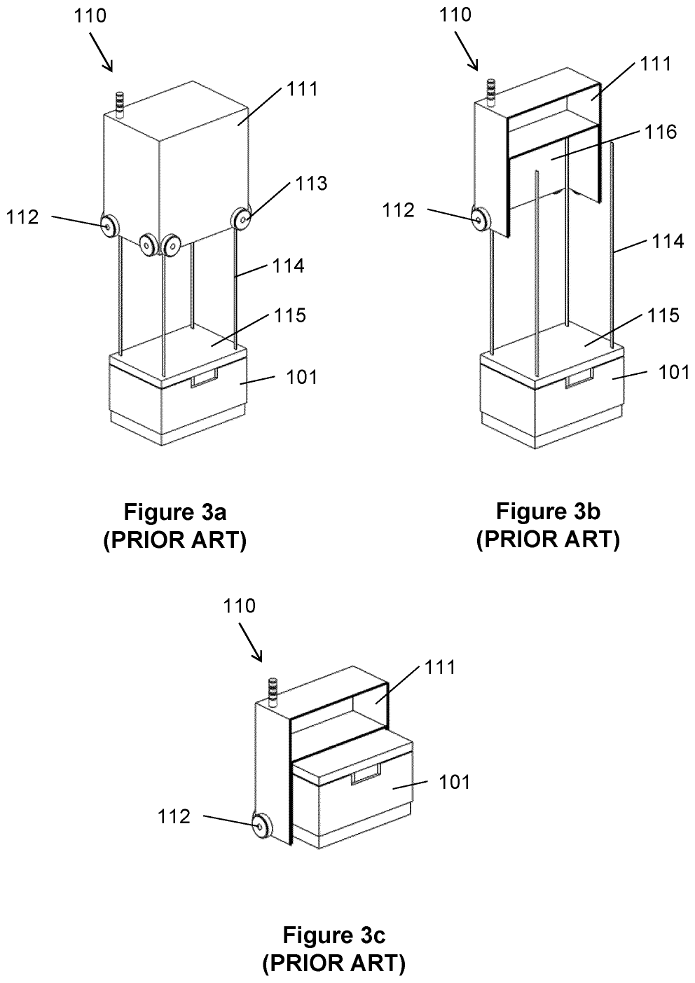

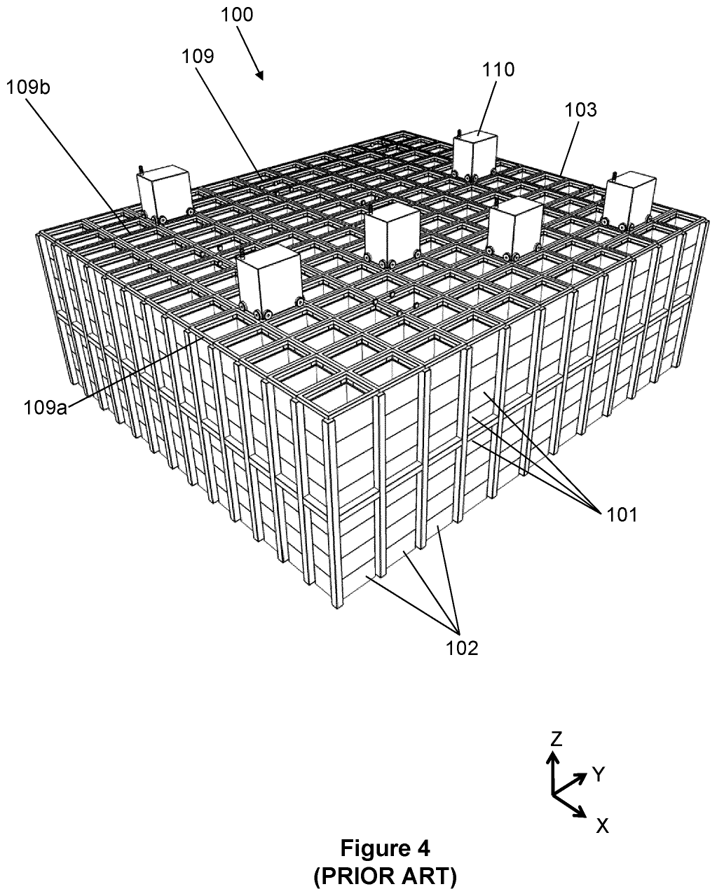

The top level of the frame structure 105 then comprises the grid 103. The grid 103 comprises rails or tracks 109 supported on the upright members 106 and arranged in a grid pattern above the stacks 102. Referring additionally to FIGS. 3a, 3b, 3c and 4, the tracks 109 support a plurality of load handling devices 110. A first set 109a of parallel tracks 109 guide movement of the load handling devices 110 in a first direction (X) across the top of the grid 103, and a second set 109b of parallel tracks 109, arranged perpendicular to the first set 109a, guide movement of the load handling devices 110 in a second direction (Y), perpendicular to the first direction. In this way, the tracks 109 allow movement of the load handling devices 110 in two dimensions in the X-Y plane, so that a load handling device 110 can be moved into position above any of the stacks 102.

As shown in FIGS. 3a, 3b and 3c, each load handling device 110 comprises a vehicle 111 which is arranged to travel in the X and Y directions on the tracks 109 of the gird 103, above the stacks 102. A first set of wheels 112, consisting of a pair of wheels 112 on the front of the vehicle 111 and a pair of wheels 112 on the back of the vehicle 111, are arranged to engage with two adjacent tracks of the first set 109a of tracks 109. Similarly, a second set of wheels 113, consisting of a pair of wheels 113 on each side of the vehicle 111, are arranged to engage with two adjacent tracks of the second set 109b of tracks 109. Each set of wheels 112, 113 can be lifted and lowered, so that either the first set of wheels 112 or the second set of wheels 113 is engaged with the respective set of tracks 109a, 109b at any one time.

When the first set of wheels 112 is engaged with the first set of tracks 109a and the second set of wheels 113 are lifted clear from the tracks 109, the wheels 112 can be driven, by way of a drive mechanism (not shown) housed in the vehicle 111, to move the load handling device 110 in the X direction. To move the load handling device 110 in the Y direction, the first set of wheels 112 are lifted clear of the tracks 109, and the second set of wheels 113 are lowered into engagement with the second set of tracks 109a. The drive mechanism can then be used to drive the second set of wheels 113 to achieve movement in the Y direction. In this way, one or more load handling devices 110 can move around on the grid 103 above the stacks 102 under the control of a central control system (not shown).

FIG. 4 shows a storage system 100 as described above with reference to FIGS. 1 and 2, the system having a plurality of load handling devices 110 active on the grid 103 above the stacks 102. Each load handling device 110 comprises a container-lifting device 114, 115 configured to raise and lower containers 101. In the example illustrated in FIGS. 3a, 3b and 3c, the container-lifting device 114, 115 comprises winch cables or tethers 114 that are arranged to extend in a vertical direction, whose upper ends are attached to the vehicle 111 and whose lower ends are connected to a releasable container-engaging assembly 115. The container-engaging assembly 115 comprises engaging devices (which may, for example, be provided at the corners of the assembly 115) configured to releasably engage with features of the containers 101. For instance, the containers 101 may be provided with one or more apertures in their upper sides with which the engaging devices can engage. Alternatively or additionally, the engaging devices may be configured to hook under rims or lips of the containers 101, and/or to clamp or grasp the containers 101. The cables 114 may be wound up or down to raise or lower the container-engaging assembly 115, as required. One or more motors or other means may be provided to effect or control the winding up or down of the cables 114. The cables 114 and the one or more motors may together form a raising and lowering assembly configured to raise and lower the container-engaging assembly 115.

The wheels 112, 113 are arranged around the periphery of a cavity or recess, known as a container-receiving recess 116, provided by the vehicle 111. The recess is sized to accommodate the container 101 when it is lifted by the container-lifting device, as shown in FIG. 3c. When in the recess 116, the container 101 is lifted clear of the tracks 109 beneath, so that the vehicle 111 can move laterally to a different location. On reaching the target location, for example another stack, an access point in the storage system or a conveyor belt, the container 101 can be lowered from the container receiving recess 116 and released from the container-lifting device. In this way, each load handling device 110 is able to lift a storage container 101 from beneath the grid 103 of a storage system of the type shown in FIG. 1, and transport the storage container 101 to another location within the system.

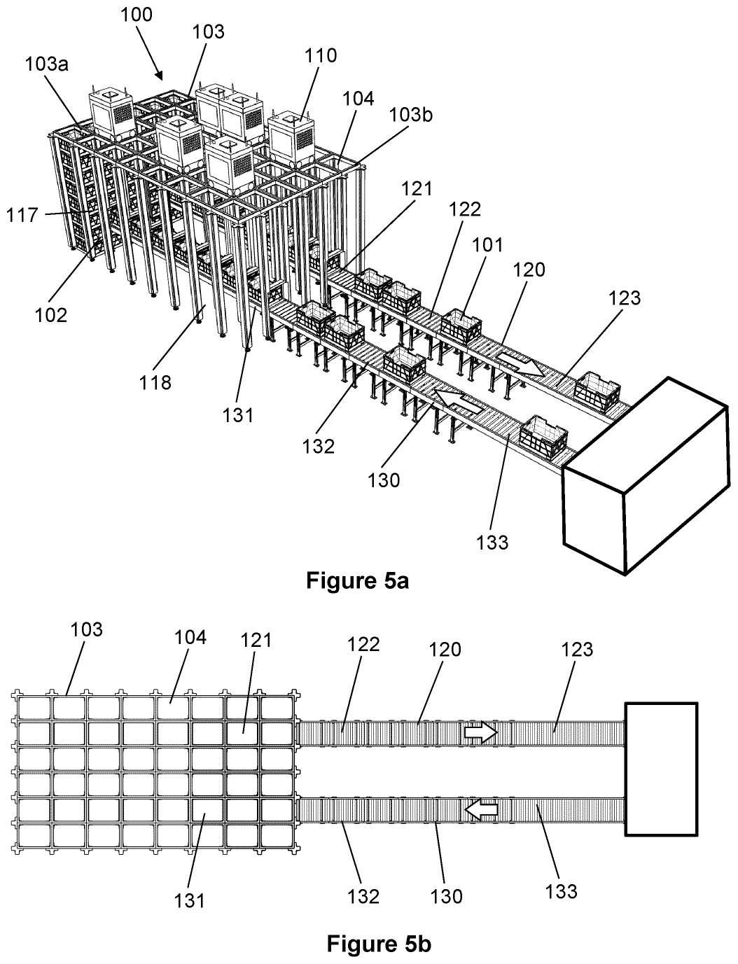

FIGS. 5a and 5b then show an arrangement of a storage and retrieval system 100 such as that illustrated in FIGS. 1 and 4 in which the system further comprises both an outbound container conveyor 120 and an inbound container conveyor 130 that provide an interface with the grid 103. The outbound container conveyor 120 is arranged to transport containers 101 outward from beneath the grid 103 (i.e. from within the workspace), whilst the inbound container conveyor 130 is arranged to transport containers 101 inward to beneath the grid 103 (i.e. within the workspace). The load handling devices 110 are then configured to both lower and raise containers 101 to and from the stacks 102 stored beneath the grid 103 and to lower and raise the containers 101 to and from the portion of each container conveyor 120, 130 that is disposed beneath the grid 103.

By way of example, the outbound container conveyor 120 may be arranged to transport containers 101 out from beneath the grid 103 to a sub-system or system that is external to the workspace (i.e. that is not beneath the grid 103), with the inbound container conveyor 130 being arranged to transport containers 101 back to the workspace beneath the grid 103 from the external sub-system or system. In such an arrangement, the outbound and inbound container conveyors 120, 130 then provide an interface between the grid 103 and external sub-systems and/or external systems. Examples of external subs-systems include peripherals, such as pick stations, decant stations, etc. and any other parts of the system, such as loading areas or separate grids that form part of the storage and retrieval system 100. By way of further example, the outbound container conveyor 120 may be arranged to transport containers 101 out from a first area beneath the grid 103 and back in to a second area beneath the grid 103, with the inbound container conveyor 130 being arranged to transport containers 101 out from the second area beneath the grid 103 space and back in to the first area beneath the grid 103.

In the arrangement illustrated in FIGS. 5a and 5b, the grid 103 comprises a storage interface portion 103a and a conveyor interface portion 103b. The storage interface portion 103 of the grid 103 extends over a storage portion 117 of the workspace that is arranged to store containers 101 in stacks 102. In particular, the storage interface portion 103a of the grid 103 is arranged such that the load handling devices 110 can lower and raise containers 101 to and from stacks 102 located within the storage portion 117 of the workspace.

The container conveyors 120, 130 are then partially disposed within a conveyor interface portion 103b of the grid 103. In particular, each container conveyor 120, 130 comprises a grid interface section 121, 131 that is at least partially disposed beneath a conveyor interface portion 103b of the grid 103, within a conveyor portion 118 of the workspace, such that that the load handling devices 110 can lower and raise containers 101 to and/or from the grid interface section 121, 131 of the container conveyor 120, 130. As a consequence, stacks of containers 101 are not stored beneath the conveyor interface portion 103b of the grid 103. As shown in FIGS. 5a and 5b, it is a distal end of each conveyor 120, 130 that provides the grid interface section 121, 131 that is disposed beneath the grid 103.

As described above, the grid 103 defines grid spaces 104. Each stack 102 of containers 101 within the storage portion 117 of the workspace is then disposed beneath and aligned with a grid space 104 such that the containers 101 in a stack 102 can be accessed through a grid space 104. The grid interface section 121, 131 of each conveyor 120, 130 is then also arranged to extend beneath a plurality of the grid spaces 104, within a conveyor portion 118 of the workspace, and is aligned with the grid spaces 104 such that the container conveyor 120, 130 can be accessed through the grid spaces 104. In particular, each grid interface section 121, 131 is arranged beneath a plurality of the grid spaces 104 of a conveyor interface portion 103b of the grid 103 so that it has a plurality of transfer positions at which containers 101 supported on the container conveyor 120, 130 are aligned with the grid spaces 104, and from which the containers 101 can be dropped-off and/or picked-up by the load handling devices 110. Each grid interface section 121, 131 is therefore arranged to support a container 101 beneath each of the plurality grid spaces 104 simultaneously and to be able to convey these containers 101 to and/or from the transfer positions beneath the grid spaces 104.

In the arrangement illustrated in FIGS. 5a and 5b, the grid interface sections 121, 131 of the outbound container conveyor 120 and the inbound container conveyor 130 are parallel to one another and are arranged such that they are separated by only two grid spaces 104. This arrangement provides for efficient utilisation of the load handling devices 110 when interfacing with the container conveyors 120, 130. In particular, arranging the grid interface sections 121, 131 of the outbound container conveyor 120 and the inbound container conveyor 130 such that they are adjacent to one another provides that load handling devices 110 can drop-off a first container 101 on the outbound container conveyor 120 and then collect a second container 101 from the inbound container conveyor 130 with a minimal interval. This can be achieved by minimising the number of grid spaces 104 that separate the grid spaces 104 above an outbound container conveyor 120, referred to herein as outbound grid spaces, from the grid spaces 104 above an inbound container conveyor 130, referred to herein as inbound grid spaces. Consequently, in some arrangements it may be preferable that the outbound grid spaces are immediately adjacent to the inbound grid spaces. However, in other arrangements it may be preferable to have at least some separation between the outbound grid spaces and the inbound grid spaces in order to allow a plurality of load handling devices 110 to simultaneously move to and from the outbound grid spaces and the inbound grid spaces without obstructing and delaying one another. Consequently, it may be preferable that the outbound grid spaces are separated from the inbound grid spaces by at least one grid space 104 and no more than four grid spaces 104.

In the arrangement illustrated in FIGS. 5a and 5b, each container conveyor 120, 130 comprises a plurality of conveyor sections that are independently operable. In particular, each container conveyor 120, 130 comprises a grid interface section 121, 131 that is at least partially disposed beneath a conveyor interface portion 103b of the grid 103 and then further comprises at least one further section 122, 123, 132, 133 that is connected to the grid interface section 121, 131 and that is arranged to convey containers 101 to or from the grid interface section 121, 131. As described above, for an outbound container conveyor 120 the grid interface section 121 is arranged to receive containers 101 that are lowered and deposited onto the outbound container conveyor 120 by the load handling devices 110, whereas for an inbound container conveyor 130 the grid interface section 131 is arranged to present containers 101 that are to be lifted from the inbound container conveyor 130 by the load handling devices 110. The independent operation of the grid interface section 121, 131 relative to any further sections then provides that containers 101 can be conveyed towards or away from the grid interface section 121, 131 by one or more further sections 122, 123, 132, 133 whilst the grid interface section 121, 131 is stationary. For example, the one or more further sections 122, 123, 132, 133 can continue to convey containers 101 whilst the grid interface section 121, 131 is stationary during the exchange of containers 101 between the container conveyor 120, 130 and the load handling devices 110.

In the arrangement illustrated in FIGS. 5a and 5b, each container conveyor 120, 130 comprises three separate conveyor sections 121, 122, 123, 131, 132, 133 that are independently operable. Specifically, each container conveyor 120, 130 comprises a first conveyor section that is at least partially disposed beneath the grid 103, a second conveyor section 122, 132 that is connected to the first conveyor section and that is arranged to convey containers 101 to or from the first conveyor section 121, 131, and a third conveyor section 123, 133 that is connected to the second conveyor section 122, 132 and that is arranged to convey containers 101 to or from the second conveyor section 122, 132. The first conveyor section therefore functions as the above described grid interface section 121, 131, whilst the second and third conveyor sections 122, 123, 132, 133 are connected sequentially to the grid interface section 121, 131 and extend at least partially away from beneath the grid 103. This arrangement provides that the third conveyor section 123, 133 can convey containers to or from the second conveyor section 122, 132, even whilst the second conveyor section 122, 132 is held stationary. For example, this may allow the second conveyor section 122, 132 to build-up a queue of containers 101 that are to be conveyed to or from the first conveyor section (i.e. the grid interface section 121, 131) independently of the operation of the third conveyor section 123, 133.

In an optional arrangement, the second conveyor section 122, 132 of each container conveyor 120, 130 may function as an accumulation section that is arranged to allow containers 101 to queue on the accumulation section of the container conveyor 120, 130. In doing so, the accumulation section 122, 132 functions as a buffer that decouples the upstream processes from the downstream processes and improves the throughput of the system. By way of example, the accumulation section 122, 132 may comprise an independently operable section of the container conveyor 120, 130 that is arranged to be activated and deactivated in such a way that containers 101 delivered to/received by the accumulation section 122, 132 are arranged in a queue (e.g. at regular intervals) on the accumulation section 122, 132. By way of further example, the accumulation section 122, 132 may comprise a zoned conveyor section that comprises a plurality of independently operable accumulation zones that are each configured to receive and transport individual containers 101. The accumulation section 122, 132 may therefore comprise at least one drive mechanism (not shown) that is arranged to allow each accumulation zone to be driven independently of the other accumulations zones. The accumulation section 122, 132 may further comprise a plurality of accumulation sensors (not shown), with each accumulation sensor being arranged to detect the presence of a container 101 at a different location on the accumulation section. A central controller (not shown) may then use the outputs of these accumulation sensors to control the movement of containers 101 along the accumulation section 122, 132 such that containers 101 delivered to/received by the accumulation section 122, 132 are arranged in a queue (e.g. at regular intervals) on the accumulation section 122, 132. In particular, where the accumulation section 122, 132 comprises a zoned conveyor section, the accumulation section 122, 132 may comprise at least one accumulation sensor for each accumulation zone, with each accumulation sensor being configured to detect the presence of a container 101 within the corresponding accumulation zone.

The further, third conveyor section 123, 133 is then connected to the accumulation section 122, 132 and is arranged to convey containers 101 to or from the accumulation section 122, 132. In the arrangement illustrated in FIGS. 5a and 5b, the grid interface section 121, 131 of each container conveyor 120, 130 is disposed entirely beneath the grid 103, with the accumulation section 122, 132 then extending out from beneath the grid 103 before connecting to the further, third conveyor section 123, 133 that is entirely beyond the grid 103. Such an arrangement optimises the use of space underneath the grid 103 by limiting the space required to accommodate the conveyors 120, 130 beneath the grid 103.

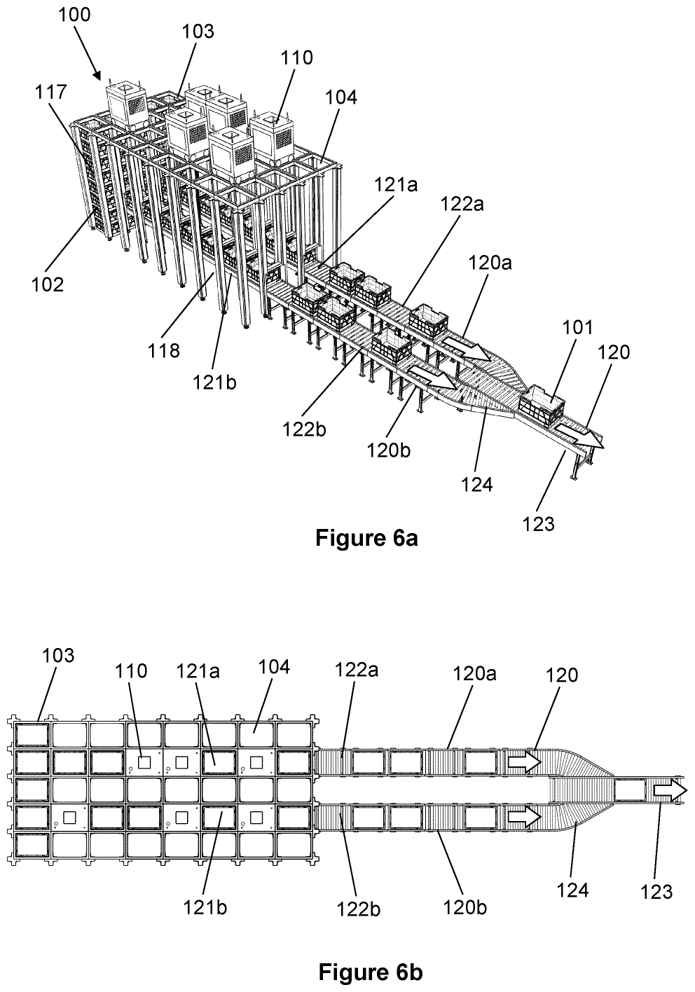

FIGS. 6a, 6b and 6c then show alternative arrangements of a storage and retrieval system 100 such as that illustrated in FIGS. 1 and 4 in which the system 100 further comprises a furcated container conveyor 120, 130 that divides into two or more branches. Such a furcated container conveyor increases the rate at which containers 101 can be transferred between the grid 103 and the container conveyor 120, 130 whilst optimising both the usage of the conveyor capacity and the space consumed.

In the arrangement illustrated in FIGS. 6a and 6b, the storage and retrieval system 100 comprises a furcated outbound conveyor 120 that diverges into two separate branches 120a, 120b (i.e. a bifurcated outbound container conveyor), each branch 120a, 120b comprising a grid interface section 121a, 121b that is at least partially disposed beneath a conveyor interface portion 103b of the grid 103. Such a furcated outbound container conveyor 120 therefore comprises two separate grid interface sections 121a, 121b, a single downstream section 123 that functions as a stem from which the branches divide, and a convergent section 124 that functions as a junction connecting the single downstream section 123 to the two grid interface sections 121a, 121b. The convergent section 124 is then arranged to direct or merge each container 101 conveyed from the two grid interface sections 121a, 121b onto the downstream section 123. Preferably, the convergent section 124 is arranged to selectively direct or merge each container 101 conveyed from the two grid interface sections 121a, 121b towards the downstream section 123 under the control of a central controller (not shown). Such an approach allows the control system to use the outbound container conveyor 120 to control the timing and/or order in which containers 101 are transported out from the grid 103.

In the arrangement illustrated in FIGS. 6a and 6b, the branches 120a, 120b of the furcated outbound container conveyor 120 are parallel to one another and are arranged such that they are separated by only a single grid space 104. As described above, such an arrangement provides for efficient utilisation of the load handling devices 110 when interfacing with the conveyor 120. However, as also described above, it may be preferable that the branches 120a, 120b of the furcated outbound container conveyor 120 are separated by at least one grid space 104 and by no more than four grid spaces 104.

In the arrangement illustrated in FIGS. 6a and 6b, the furcated outbound container conveyor 120 further comprises two accumulation sections 122a, 122b. Specifically, each branch 120a, 120b of the furcated outbound container conveyor 120 comprises a grid interface section 121a, 121b and an accumulation section 122a, 122b. For each branch 120a, 120b, the grid interface section 121a, 121b is then connected to the accumulation section 122a, 122b, with the accumulation section 122a, 122b then connecting the grid interface section 121a, 121b to the convergent section 124.

In the arrangement illustrated in FIG. 6c, the storage and retrieval system 100 comprises a furcated inbound container conveyor 130 that diverges into two separate branches 130a, 130b (i.e. a bifurcated inbound container conveyor), each branch 130a, 130b comprising a grid interface section 121a, 121b that is at least partially disposed beneath a conveyor interface portion 103b of the grid 103. Such a furcated inbound container conveyor 130 therefore comprises two separate grid interface sections 131a, 131b, a single upstream section 133 that functions as a stem from which the branches divide, and a divergent section 134 that functions as a junction connecting the single upstream section 133 to the two or more grid interface sections 131a, 131b. The divergent section 134 is then arranged to direct or divert each container 101 conveyed from the upstream section 133 towards one of the two grid interface sections 131a, 131b. Preferably, the divergent section 134 is arranged to selectively direct or divert each container 101 conveyed from the upstream section 133 towards one of the two grid interface sections 131a, 131b under the control of a central controller (not shown). Such an approach allows the control system to use the inbound container conveyor 130 to control the timing and/or order in which containers 101 are delivered to the conveyor portion 118 of the workspace beneath the grid 103, which may be useful when managing the tasks undertaken by the load handling devices 110 that collect the containers 101 from the conveyor interface portion 118.

In the arrangement illustrated in FIG. 6c, the branches 130a, 130b of the furcated inbound container conveyor 130 are parallel to one another and are arranged such that they are separated by only a single grid space 104. As described above, such an arrangement provides for efficient utilisation of the load handling devices 110 when interfacing with the container conveyor 130. However, as also described above, it may be preferable that the branches 130a, 130b of the furcated inbound container conveyor 130 are separated by at least one grid space 104 and by no more than four grid spaces 104.

In the arrangements illustrated in FIG. 6c, the furcated inbound container conveyor 130 further comprises two accumulation sections 132a, 132b. Specifically, each branch 130a, 130b of the furcated inbound container conveyor 130 comprises a grid interface section 131a, 131b and an accumulation section 132a, 132b. For each branch 130a, 130b, the grid interface section 131a, 131b is then connected to the accumulation section 132a, 132b, with the accumulation section 132a, 132b then connecting the grid interface section 131a, 131b to the divergent section 134.

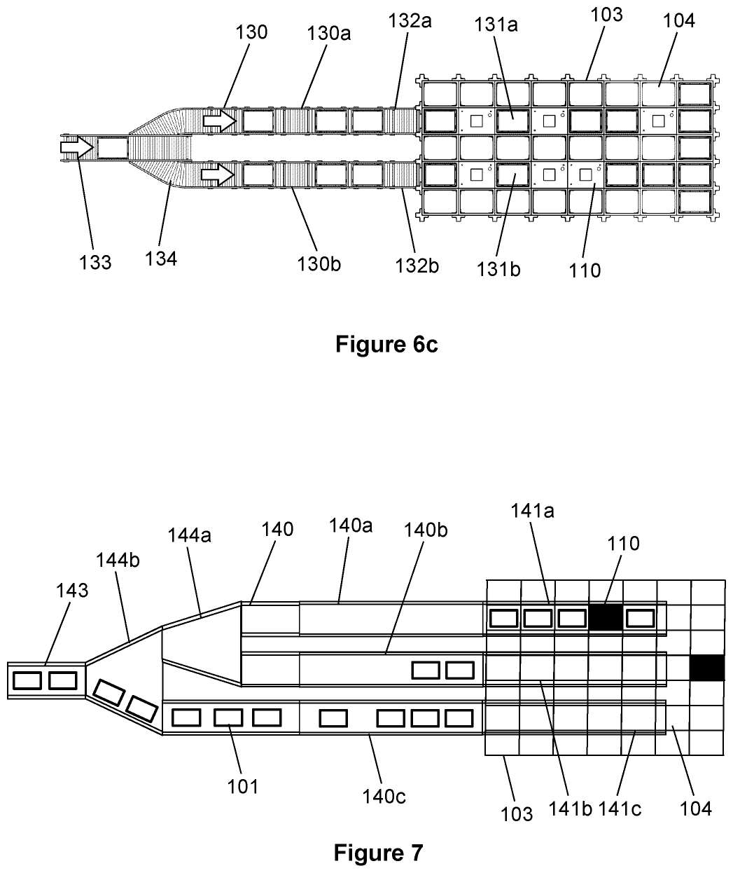

Whilst the arrangement described above in relation to FIGS. 6a, 6b, and 6c each comprise a furcated container conveyor having two branches, each branch comprising a grid interface section, these arrangements could equally have more than two branches. By way of example, FIG. 7 illustrates schematically an arrangement that comprises a furcated container conveyor 140 that diverges into three separate branches 140a, 140b, 140c (i.e. a trifurcated container conveyor), each branch 140a, 140b, 140c comprising a grid interface section 141a, 141b, 141c that is at least partially disposed beneath a conveyor interface portion 103b of the grid 103. In this example, the furcated container conveyor 140 comprises three separate grid interface sections 141a, 141b, 141c, a first junction (i.e. a convergent or divergent) section 144a section, a second junction section 144b, and a single stem (i.e. upstream or downstream) section 143. The first junction section 144a is directly connected to the two of the three grid interface sections 141a, 141b, and to the second junction section 144b. The second junction section 144b is then directly connected to the remaining grid interface section 141c and to the single stem section 143. In this way, each of the junction sections 144a, 144b need only merge or diverge two conveyor sections into/from one other conveyor section.

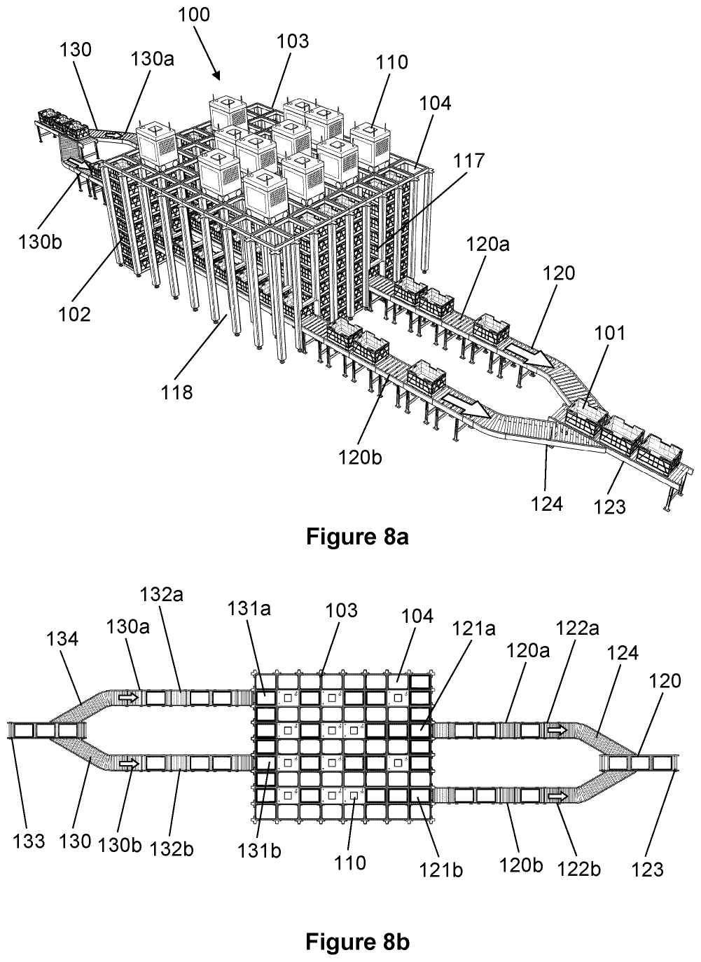

FIGS. 8a and 8b then show an arrangement of a storage and retrieval system 100 such as that illustrated in FIGS. 1 and 4 in which the system further comprises a furcated outbound container conveyor 120 and a furcated inbound container conveyor 130. The furcated outbound container conveyor 120 is essentially the same as that described above in relation to FIGS. 6a and 6b and the furcated inbound container conveyor 130 is essentially the same as that described above in relation 6c.

In the arrangement illustrated in FIGS. 8a and 8b, the furcated outbound container conveyor 120 and the furcated inbound container conveyor 130 are arranged such that their branches 120a, 120b, 130a, 130b are at least partially parallel to one another and are arranged such that each grid interface section 121a, 121b of the furcated outbound container conveyor 120 is adjacent to a grid interface section 131a, 131b of the furcated inbound container conveyor 130. Consequently, each grid interface section 131a, 131b of the furcated inbound container conveyor 130 is adjacent to a grid interface section 121a 121b of the furcated outbound container conveyor 120. In other words, the grid interface sections 121a, 121b, 131a, 131b of the furcated outbound container conveyor 120 and the furcated inbound container conveyor 130 are alternately distributed. The grid interface sections 121a 121b, 131a, 131b of the furcated outbound container conveyor 120 and the furcated inbound container conveyor 130 are then only separated by a single grid space 104 that, as described above, provides for efficient utilisation of the load handling devices 110 when interfacing with the container conveyors 120, 130. Such an arrangement increases the rate at which containers 101 can be transferred between the grid 103 and the container conveyors 120, 130 whilst optimising both the usage of the conveyor capacity and the space consumed.

In the arrangement illustrated in FIGS. 8a and 8b, the grid interface sections of the furcated outbound container conveyor 120 and the furcated inbound container conveyor 130 are interdigitated. In other words, the grid interface sections 121a, 121b, 131a, 131b of the furcated outbound container conveyor 120 and the furcated inbound container conveyor 130 are parallel to one another, extend in opposite directions and are alternately distributed. In the illustrated arrangement, the workspace beneath grid 103 comprises conveyor portions 118 that are accessible from two opposing, open sides of the grid 103. The furcated outbound container conveyor 120 can then extend out from a conveyor interface portion 118 at a first open side of the grid 103 and the furcated inbound container conveyor 130 can extend out from a conveyor interface portion 118 at an opposing, second open side of the grid 103. However, in an alternative arrangement, the furcated outbound container conveyor 120 and the furcated inbound container conveyor 130 could be arranged such that they are interspersed and extend in the same direction relative to the grid 103. For example, in such an arrangement, the furcated outbound container conveyor 120 and the furcated inbound container conveyor 130 could be disposed at different heights, one above the other in order to avoid obstruction. The conveyor interface portion 118 of the workspace beneath the grid 103 would then only need to have one open side and could therefore be provided by a portion of one side of the grid 103.

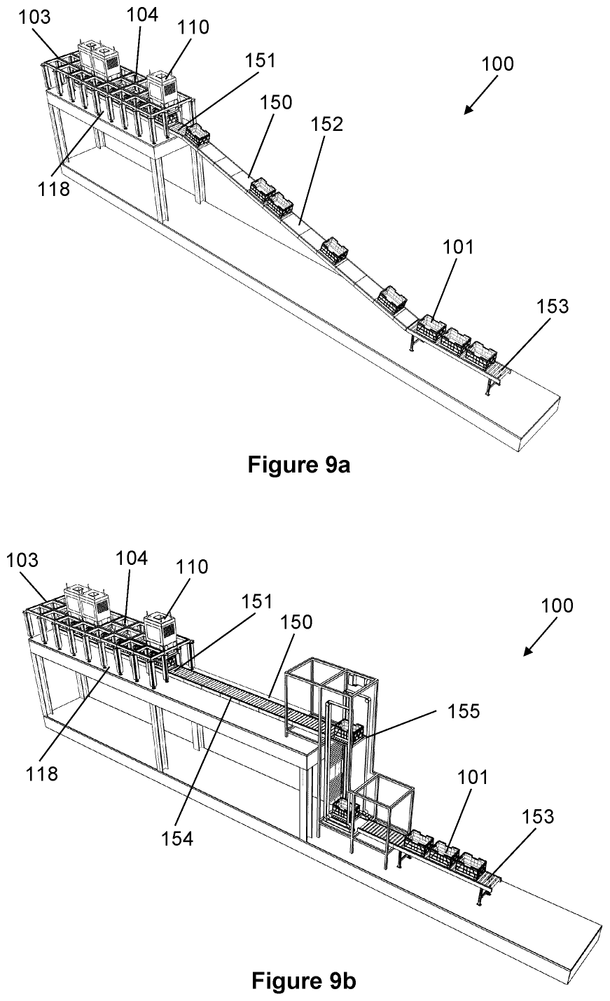

In the arrangements shown in FIGS. 5a, 6a and 8a, each section of the container conveyors 120, 130 is horizontal such that there is no change in the height of the containers 101 as they move along the container conveyors 120, 130. In particular, in the arrangements shown in FIGS. 5a, 6a and 8a, the grid interface section 121, 131 of each container conveyor 120, 130 is close to the floor beneath the grid 103 such that there is no need to change the height at which the containers 101 are transported. However, depending on the height of the grid interface section 121, 131 relative to the grid 103, it may be desirable to configure the container conveyors 120, 130 such that at least one section of the container conveyor 120, 130 is configured to transport containers 101 in a direction that is at least partially vertical, e.g. vertically, sloped. By way of example, FIGS. 9a, 9b and 9c illustrate examples of systems in which a container conveyor 150 comprises a grid interface section 151 that is raised so as to be vertically adjacent to the grid 103 (i.e. closer to the grid than to the floor beneath the grid). Such an arrangement reduces the time needed to transfer containers 101 between the container conveyor 150 and the load handling devices 110 due to the decrease in the distance between the grid 103 and the container conveyors 150. Consequently, each of the container conveyors 150 illustrated in FIGS. 9a, 9b and 9c comprises at least one section of conveyor that is configured to transport containers 101 in a direction that is at least partially vertical.

FIG. 9a illustrates an arrangement in which a container conveyor 150 comprises a horizontal grid interface section 151 that is vertically closer to the grid 103 than to the floor beneath the grid 103. The container conveyor 150 then comprises a sloped section 152, and a horizontal further section 153 that is lower than the grid interface section 151. The sloped section 152 connects the grid interface section 151 to the further section 153, with the slope of the sloped section 152 providing that the containers 101 transported on the sloped section 152 are raised or lowered accordingly in order to traverse the vertical separation between them. In particular, for an inbound container conveyor, the further section 153 would be arranged to convey containers 101 horizontally to the sloped section 152, and the sloped section 152 would then be arranged to convey containers 101 up the inclined surface of the sloped section 152 to the grid interface section 151. For an outbound container conveyor, the grid interface section 151 would be arranged to convey containers 101 horizontally to the sloped section 152, and the sloped section 152 would then be arranged to convey containers 101 down the declined surface of the sloped section 152 to the horizontal further section 153. In this particular example, the sloped section 152 is also arranged to function as an accumulation section.

FIG. 9b illustrates a further arrangement in which the container conveyor 150 comprises a horizontal grid interface section 151 that is vertically closer to the grid 103 than to the floor beneath the grid 103. The container conveyor 150 then comprises a horizontal intermediate section 154 that is at the same height as the grid interface section 151, a vertical section 155, and a horizontal further section 153 that is lower than the grid interface section 151. The intermediate section 154 connects the grid interface section 151 to the vertical section 155, and the vertical section 155 then connects the intermediate section 154 to the further section 153 and raises or lowers containers 101 accordingly in order to traverse the vertical separation between them. In particular, for an inbound container conveyor, the further section 153 would be arranged to convey containers 101 horizontally to the vertical section 155, and the vertical section 155 would then be arranged to convey containers 101 vertically upward to the intermediate section 154. For an outbound container conveyor, the grid interface section 151 would be arranged to convey containers 101 horizontally to the intermediate section 154, the intermediate section 154 would be arranged to convey containers horizontally to the vertical section 155 and the vertical section 155 would then be arranged to convey containers 101 vertically downward to the further section 153. In this particular example, the vertical section 155 comprises a continuous vertical conveyor. However, the vertical section 155 could be provided by any other suitable form of vertical conveyor. In this particular example, the intermediate section 154 is also arranged to function as an accumulation section.

FIG. 9c illustrates a yet further arrangement in which the container conveyor 150 comprises a horizontal grid interface section 151 that is vertically closer to the grid 103 than to the floor beneath the grid 103. The container conveyor 150 then comprises a horizontal intermediate section 154 that is at the same height as the grid interface section 151, a vertical section 155, and a horizontal further section 153 that is lower than the grid interface section 151. The intermediate section 154 connects the grid interface section 151 to the vertical section 155, and the vertical section 155 then connects the intermediate section 154 to the further section 153 and raises or lowers containers 101 accordingly in order to traverse the vertical separation between them. In particular, for an inbound container conveyor, the further section 153 would be arranged to convey containers 101 horizontally to the vertical section 155, and the vertical section 155 would then be arranged to convey containers 101 vertically upward to the intermediate section 154. For an outbound container conveyor, the grid interface section 151 would be arranged to convey containers horizontally to the intermediate section 154, the intermediate section 154 would be arranged to convey containers 101 horizontally to the vertical section 155 and the vertical section 155 would then be arranged to convey 101 containers vertically downward to the further section 153. In contrast with the arrangement of FIG. 9b, the arrangement illustrated in FIG. 9c does not have an accumulation section between the grid interface section 151 and the vertical section 155, but instead has a vertical section 155 that is arranged to also function as an accumulation section.

Consequently, whilst FIGS. 5a, 6a and 8a show arrangements in which each section of the container conveyors 120, 130 is horizontal, any of these arrangements could be modified such that the grid interface section 121, 131 is raised so as to be vertically closer to the grid 103 than to the floor beneath the grid 103 and to then include a sloped or vertical section, such as those illustrated in FIGS. 9a, 9b and 9c.

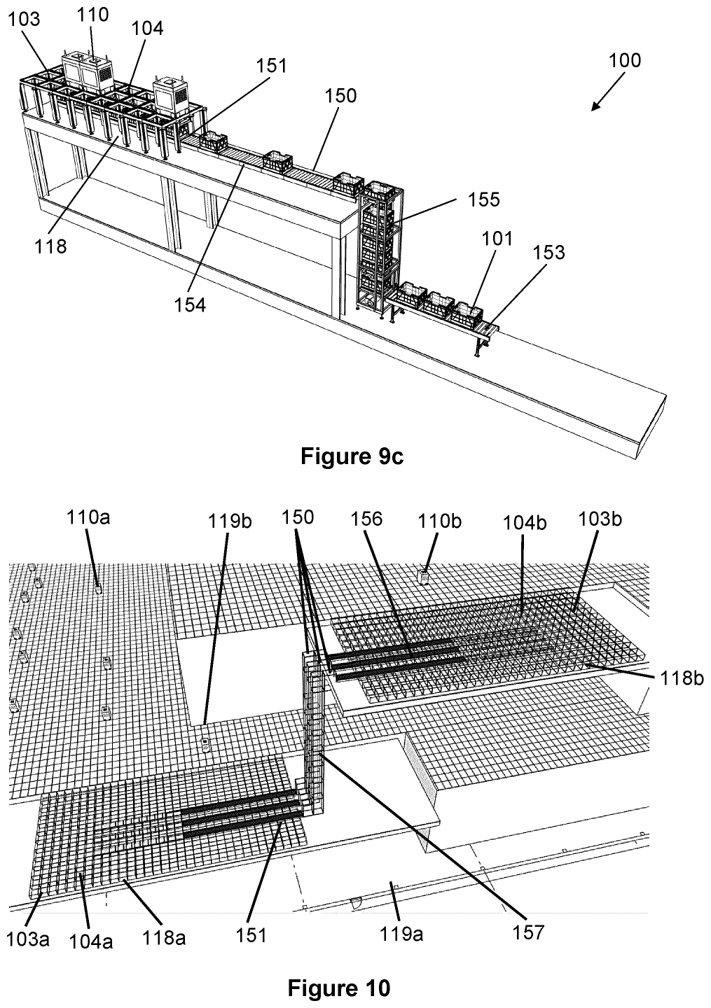

FIG. 10 shows an arrangement of a storage and retrieval system 100 such as that illustrated in FIGS. 1 and 4 in which the system 100 further comprises a multi-level grid 103 and a number of container conveyors 150 that provide an interface between each level of the multi-level grid 103.

In the arrangement illustrated in FIG. 10, the multi-level grid 103 comprises a first level grid 103a and a second level grid 103b, with the first level grid 103a being lower than the second level grid 103b. The system 100 then comprises a plurality of containers 101 that are located in stacks beneath the first level grid 103a and in stacks beneath the second level grid 103b. Specifically, the plurality of containers are 101 distributed between a first set of stacks that are disposed within a first workspace beneath the first level grid 103a and a second set of stacks that are disposed within a second workspace beneath the second level grid 103b.

Each of the container conveyors 150 then comprises a first grid interface section 151 that is at least partially disposed beneath the first level grid 103a, a second grid interface section 156 that is at least partially disposed beneath the second level grid 103b, and an intermediate section 157 that connects the first grid interface section 151 to the second grid interface section 156. A first plurality of robotic load handling devices 110a are then arranged to move along the first level grid 103a and are configured to move containers between the stacks located beneath the first level grid 103a and the first grid interface section 151 of each container conveyor 150. A second plurality of robotic load handling devices 110b are then arranged to move along the second level grid 103b and are configured to move containers between the stacks located beneath the second level grid 103b and the second grid interface section 156 of each container conveyor 150.

The intermediate section 157 of each container conveyor 150 is arranged to convey containers 101 between the first grid interface section 151 and the second grid interface section 156. In the arrangement illustrated in FIG. 10, both the first grid interface section 151 and the second grid interface section 156 of each container conveyor 150 extends substantially horizontally, with the intermediate sections 157 then being configured to transport containers 101 in a direction that is at least partially vertical, e.g. that is configured to transport containers 101 vertically or along a slope, and thereby transport containers 101 over the vertical separation between the first level grid 103a and the second level grid 103b.

For each container conveyor 150, the first grid interface section 151 is arranged to extend beneath a plurality of the grid spaces 104a defined by the first level grid 103a, within a conveyor portion 118a of the first workspace beneath the first level grid 103a, and is aligned with the grid spaces 104a such that the container conveyor 150 can be accessed through the grid spaces 104a. In particular, the first grid interface section 151 of each container conveyor 150 is arranged beneath a plurality of the grid spaces 104a of a conveyor interface portion of the first level grid 103a so that it has a plurality of transfer positions at which containers 101 supported on the container conveyor 150 are aligned with the grid spaces 104a, and from which the containers 101 can be dropped-off and/or picked-up by the first plurality of load handling devices 110a operating on the first level grid 103a. The first grid interface section 151 of each conveyor 150 is therefore arranged to support a container 101 beneath each of the plurality grid spaces 104a simultaneously and to be able to convey these containers 101 to and/or from the transfer positions beneath the grid spaces 104a of the first level grid 103a.

For each container conveyor 150, the second grid interface section 156 is then arranged to extend beneath a plurality of the grid spaces 104b defined by the second level grid 103b, within a conveyor portion 118b of the second workspace beneath the second level grid 103b, and is aligned with the grid spaces 104b such that the container conveyor 150 can be accessed through the grid spaces 104b. In particular, the second grid interface section 156 of each container conveyor 150 is arranged beneath a plurality of the grid spaces 104b of a conveyor interface portion of the second level grid 103b so that it has a plurality of transfer positions at which containers 101 supported on the container conveyor 150 are aligned with the grid spaces 104b, and from which the containers 101 can be dropped-off and/or picked-up by the second plurality of load handling devices 110b operating on the second level grid 103b. The second grid interface section 156 of each conveyor 150 is therefore arranged to support a container 101 beneath each of the plurality grid spaces 104b simultaneously and to be able to convey these containers 101 to and/or from the transfer positions beneath the grid spaces 104b of the second level grid 103b.

In the arrangement illustrated in FIG. 10, the first grid interface section 151 of each conveyor 150 is disposed towards the top of the first workspace beneath the first level grid 103a, and the second grid interface section 156 of each conveyor 150 is disposed towards the top of the second workspace beneath the second level grid 103b. In other words, the first grid interface section 151 is vertically closer to the first level grid 103a than to a first floor 119a on which the stacks beneath the first level grid 103a are supported, and the second grid interface section 156 is vertically closer to the second level grid 103b than to a second floor 119b on which the stacks beneath the second level grid 103b are supported. In particular, the first grid interface section 151 is disposed beneath the first level grid 103a such that there is sufficient vertical separation between the first grid interface section 151 and an underside of the first level grid 103a to allow a container 101 to travel horizontally along the first grid interface section 151 and with minimal additional separation. The second grid interface section 156 is then disposed beneath the second level grid 103b such that there is sufficient vertical separation between the second grid interface section 156 and an underside of the second level grid 103b to allow a container 101 to travel horizontally along the second grid interface section 156 and with minimal additional separation. Such an arrangement minimises the time needed to transfer containers 101 between the container conveyors 150 and the load handling devices 110a, 110b due to the minimal distance between the grid 103 and the container conveyors 150.

In the arrangement illustrated in FIG. 10, the system 100 comprises at least one upward container conveyor and at least one downward container conveyors. In this regard, an upward container conveyor is arranged to convey containers away from the first level grid 103a towards the second level grid 103b. Consequently, the intermediate section 157 of such an upward container conveyor is arranged to transport containers upward from the first level grid 103a towards the second level grid 103b. In contrast, a downward container conveyors is arranged to convey containers 101 away from the second level grid 103b towards the first level grid 103a. Consequently, the intermediate section 157 of such a descending container conveyor is arranged to transport containers 101 downward from the second level grid 103b towards the first level grid 103a.

In the multi-level grid, the first level grid 103a extends above and is vertically separated from the first floor 119a, such that the first workspace is defined between the first level grid 103a and the first floor 119, with the first set of stacks being disposed within the first workspace. The second level grid 103b then extends above and is vertically separated from the second floor 119b, such that the second workspace is defined between the second level grid 103b and the second floor 119b, with the second set of stacks being disposed within the second workspace.

In the arrangement illustrated in FIG. 10, the multi-level grid 103 comprises grid levels 103a, 103b that are overlaid one above the other. In particular, the second floor 119b is above the first floor 119a and extends over a portion of the first floor 119a. Consequently, the first level grid 103a is partially disposed beneath the second floor 119b and is sufficiently vertically separated from the second floor 119b to provide a space for the first plurality of robotic load handling devices 110a to operate on the first level grid 103a. The second level grid 103b is therefore disposed above the first level grid 103a such that it extends over a portion but not all of the first level grid 103a.

Whilst such an arrangement of a multi-level grid can provide for optimised usage of an area, by providing that storage space can be distributed vertically, the arrangements described herein are not limited to systems in which the levels of a multi-level grid are overlaid. In particular, the levels of the multi-level grid could be both vertically and horizontally separated, with the container conveyors 150 being arranged to convey the containers across both the vertical and horizontal separation between the grid levels. For example, the grid levels of the multi-level grid could be both vertically and horizontally separated if distributed along a slope.

In addition, whilst the container conveyors 150 of the arrangement illustrated in FIG. 10 comprise a single intermediate section 157 that is configured to transport containers 101 in a direction that is at least partially vertical, in alternative arrangements each of the container conveyors could comprise multiple intermediate sections. In particular, each container conveyor could comprise one or more intermediate sections that are arranged to convey containers in an at least partially vertical direction and one or more intermediate sections that are arranged to convey containers horizontally. For example, for a system comprising a multi-level grid in which the levels are both vertically and horizontally separated, each container conveyor could comprise a vertical or sloped intermediate section for transporting containers across the vertical separation and at least one horizontal intermediate section for transporting containers across the horizontal separation.

Furthermore, whilst the multi-level grid 103 of the arrangement illustrated in FIG. 10 comprises just a first level grid 103a and a second level grid 103b, in alternative arrangements the multi-level grid could comprise more than two separate grid levels. In such an arrangement, the system may then comprise at least one container conveyor, such as those illustrated in FIG. 10, between each level of the grid. For example, a multi-level grid having three grid levels could comprise at least one container conveyor between the first and second levels of the grid, and at least one further container conveyor between the second and third levels of the grid. Alternatively, for a multi-level grid having more than two levels, the system could comprise a container conveyor that is capable of loading and/or unloading containers at multiple levels.

It will be understood that the above description of is given by way of example only and that various modifications may be made by those skilled in the art. Although various embodiments have been described above with a certain degree of particularity, or with reference to one or more individual embodiments, those skilled in the art could make numerous alterations to the disclosed embodiments without departing from the scope of this invention. By way of example, it will be appreciated that the features described hereinabove may all be used together in a single system. In other embodiments, some of the features may be omitted. The features may be used in any compatible arrangement.

By way of further example, in the arrangements illustrated in the Figures the conveyors and each section of each conveyor is illustrated as a roller conveyor. However, each conveyor and/or each section of conveyor could comprise any of a roller conveyor device, a chain conveyor device, a slat conveyor device etc.

By way of further example, whilst the Figures mostly show arrangements in which the grid interface sections of all of the conveyors are disposed within a single conveyor portion of the workspace beneath the grid, it is equally possible that a storage and retrieval system could be provided with multiple conveyor portions beneath the grid, with each conveyor portion receiving one or more grid interface sections. In one example, for a system comprising both inbound and outbound conveyors, the grid interface sections of the inbound and outbound conveyors could be disposed within separate portions, with each conveyor portion being separated by a storage portion. In another example, for a system comprising a furcated conveyor, two or more branches of the furcated conveyor could have grid interface sections that are disposed within separate conveyor portions, with each conveyor portion being separated by a storage portion.

By way of a yet further example, in the arrangements illustrated in FIGS. 6a, 6b, 6c, 7, 8a and 8b each furcated conveyor comprises two or more branches divided from a single stem. However, in an alternative arrangement, a furcated conveyor could comprise two or more stems that divide into more than two branches. For example, a furcated conveyor could comprise two stems that divide into three or more branches. In such an arrangement, at least some of the branches would be operatively connected to more than one stem and could therefore receive containers from or convey containers to more than one stem.

1. A storage and retrieval system comprising:
a grid;
a plurality of containers located in stacks beneath the grid;
a furcated container conveyor comprising a stem and two or more branches connected to the stem by a junction, each branch comprising a grid interface section that is at least partially disposed beneath the grid, and the stem comprising at least one section that is disposed beyond the grid; and
a plurality of robotic load handling devices arranged to move along the grid and configured to move the containers between the stacks and the grid interface sections of the furcated container conveyor.

2. The storage and retrieval system according to claim 1, wherein the stacks are located beneath a storage interface portion of the grid and each grid interface section is at least partially disposed beneath a conveyor interface portion of the grid.

3. The storage and retrieval system according to claim 1, wherein the junction connects the stem to the two or more branches and is arranged to direct containers between the stem and the two or more branches.

4. The storage and retrieval system according to claim 3, wherein the junction is arranged to selectively direct containers between the stem and the two or more branches, preferably under control of a central controller.

5. The storage and retrieval system according to claim 1, wherein the grid interface sections of each branch are arranged to be parallel.

6. The storage and retrieval system according to claim 1, wherein the grid defines grid spaces, and each grid interface section is arranged beneath a plurality of the grid spaces such that the grid interface section provides a plurality of transfer positions at which containers are transferred between the grid interface section and the load handling devices.

7. The storage and retrieval system according to claim 1, wherein each branch of the furcated container conveyor comprises an accumulation section connected to the grid interface section, the accumulation section being disposed between the grid interface section and the stem.

8. The storage and retrieval system according to claim 1, wherein the furcated container conveyor is a furcated outbound container conveyor that is arranged to convey containers away from the grid, and the junction comprises a convergent section that is arranged to merge containers conveyed from the two or more branches on to the stem.

9. The storage and retrieval system according to claim 1, wherein the furcated container conveyor is a furcated inbound container conveyor that is arranged to convey containers to the grid, and the junction comprises a divergent section that is arranged to divert containers conveyed from the two or more branches on to the stem.

10. The storage and retrieval system according to claim 9, and further comprising a furcated outbound container conveyor that is arranged to convey containers away from the grid.

11. The storage and retrieval system according to claim 10, wherein the grid interface sections of the furcated outbound container conveyor and the furcated inbound container conveyor are alternately distributed.

12. The storage and retrieval system according to claim 10, wherein the grid interface sections of the furcated outbound container conveyor and the furcated inbound container conveyor are interdigitated.

13. A storage and retrieval system comprising:
a grid;
a plurality of containers located in stacks beneath the grid;
a container conveyor comprising a plurality of conveyor sections that are independently operable, the plurality of conveyor sections comprising a grid interface section, an accumulation section and at least one further section, wherein grid interface section is at least partially disposed beneath the grid, the at least one further section is disposed beyond the grid, and the accumulation section connects the grid interface section to the at least one further section; and
a plurality of robotic load handling devices arranged to move along the grid and configured to move the containers between the stacks and the grid interface sections of the container conveyor.

14. The storage and retrieval system according to claim 13, wherein the grid defines grid spaces, and each grid interface section is arranged beneath a plurality of the grid spaces such that the grid interface section provides a plurality of transfer positions at which containers are transferred between the grid interface section and the load handling devices.

15. The storage and retrieval system according to claim 13, wherein the plurality of conveyor sections comprises a section that is configured to transport containers in a direction that is at least partially vertical.

16. The storage and retrieval system according to claim 13, wherein the plurality of conveyor sections comprises an intermediate section that is disposed between the grid interface section and the at least one further section, and the intermediate section is configured to transport containers in a direction that is at least partially vertical.

17. The storage and retrieval system according to claim 13, wherein the accumulation section is configured to transport containers in a direction that is at least partially vertical.

18. The storage and retrieval system according to claim 13, wherein the container conveyor is an outbound container conveyor that is arranged to convey containers away from the grid.

19. The storage and retrieval system according to claim 13, wherein the conveyor is an inbound container conveyor that is arranged to convey containers away to the grid.

20. The storage and retrieval system according to claim 19, and further comprising an outbound container conveyor that is arranged to convey containers away from the grid.

21. The storage and retrieval system according to claim 20, wherein the inbound container conveyor and the outbound container conveyor are arranged such that the grid interface section of the inbound container conveyor is parallel with and adjacent to the grid interface section of the outbound container conveyor.

22. The storage and retrieval system according to claim 20, wherein the grid defines grid spaces, each stack of containers is disposed beneath a grid space, and the grid interface sections of the inbound container conveyor and the outbound container conveyor are separated by at least one grid space and by no more than four grid spaces.

23. A storage and retrieval system comprising:
a first level grid;
a second level grid;
the first level grid being lower than the second level grid;
a plurality of containers located in stacks beneath the first level grid and in stacks beneath the second level grid;
a container conveyor comprising a first grid interface section that is at least partially disposed beneath the first level grid, a second grid interface section that is at least partially disposed beneath the second level grid, and one or more intermediate sections that connect the first grid interface section to the second grid interface section;
a first plurality of robotic load handling devices arranged to move along the first level grid and configured to move containers between the stacks beneath the first level grid and the first grid interface section of the container conveyor; and
a second plurality of robotic load handling devices arranged to move along the second level grid and configured to move containers between the stacks beneath the second level grid and the second grid interface section of the container conveyor.

24. The storage and retrieval system according to claim 23, wherein at least one of the one or more intermediate sections is configured to transport containers in a direction that is at least partially vertical.

25. The storage and retrieval system according to claim 23, wherein the container conveyor is an upward container conveyor that is arranged to convey containers away from the first grid towards the second grid.

26. The storage and retrieval system according to claim 23, wherein the container conveyor is a downward container conveyor that is arranged to convey containers away from the second grid towards the first grid.

27. The storage and retrieval system according to claim 26, and further comprising: an upward container conveyor that is arranged to convey containers away from the first grid towards the second grid.
